(19) United States
(12) Patent Application Publication
(10) Pub. No.: US 2006/0041134 A1
(43) Pub. Date: Feb. 23, 2006

(54) Silyl ethers

(75) Inventors: Jan Koek, Bk Sauwerd (NL); Bernhard Kohl, Konstanz (DE); Jorg Senn-Bilfinger, Konstanz (DE); Ton Vries, Jm Groningen (DE)

Correspondence Address: NATH & ASSOCIATES PLLC, 112 South West Street, Alexandria, VA, 22314, US

(73) Assignee: Altana Pharma AG, Konstanz (DE)

(21) Appl. No.: 10/538,933

(22) PCT Filed: Dec. 18, 2003
(86) PCT No.: PCT/EP03/14554

§ 371 Date: Jun. 13, 2005

(30) Foreign Application Priority Data
Dec. 20, 2002 (EP) 02028672.0

(51) Int. Cl. C07F 7/02

(52) U.S. Cl. 546/14; 546/82

(57) ABSTRACT

Compounds of the formula 1, 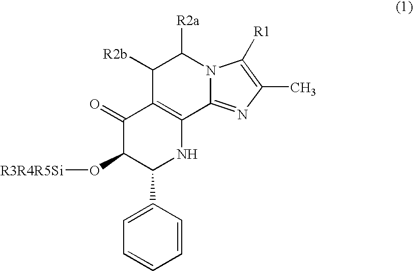 in which the substituents have the meanings mentioned in the description are valuable intermediates for preparing active compounds for the prevention and treatment of gastro-intestinal diseases.

### FIELD OF APPLICATION OF THE INVENTION

The invention relates to novel compounds, which are used in the pharmaceutical industry as intermediates for the production of medicaments.

### PRIOR ART

The international patent applications WO02/34749, WO01/72757, WO01/72756, WO01/72754, WO00/17200 and WO98/42707 disclose tricyclic imidazopyridine derivatives having a very specific substitution pattern, which are suited for the treatment of gastric and intestinal disorders. In said patent applications, reaction schemes are given in which the synthesis of the final products, starting from imidazopyridin-8-ones, is illustrated. These imidazopyridin-8-ones are described in more detail in international patent application WO01/72748.

### DESCRIPTION OF THE INVENTION

The invention relates to compounds, which can be used as important intermediates for the preparation of the compounds mentioned in the prior art, and further compounds having a similar basic structure.

The invention thus relates in a first aspect to compounds of the formula 1, 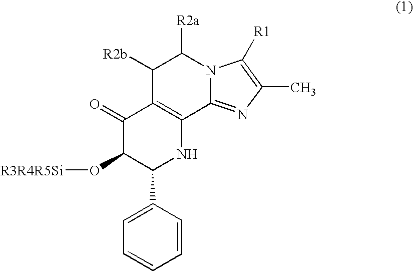
in which

R1 is hydrogen, methyl or hydroxymethyl,

R2a and R2b are both hydrogen or together denote a bond,

R3 is 1-7C-alkyl,

R4 is 1-7C-alkyl and

R5 is 1-7C-alkyl,

and their salts.

1-7C-Alkyl represents straight-chain or branched alkyl radicals having 1 to 7 carbon atoms. Examples which may be mentioned are the heptyl radical, isoheptyl radical (5-methylhexyl radical), hexyl radical, isohexyl radical (4-methylpentyl radical), neohexyl radical (3,3-dimethylbutyl radical), pentyl radical, isopentyl radical (3-methylbutyl radical), neopentyl radical (2,2-dimethylpropyl radical), butyl radical, isobutyl radical, sec-butyl radical, tert-butyl radical, propyl radical, isopropyl radical, ethyl radical and the methyl radical.

Suitable salts of compounds of the formula 1 are especially all salts with strong bases, for example the sodium, potassium or lithium salt.

Compounds of the formula 1 to be emphasized are those, in which

R1 is methyl,

R2a and R2b are both hydrogen or together denote a bond,

R3 is 1-7C-alkyl,

R4 is 1-4C-alkyl and

R5 is 1-4C-alkyl,

and their salts.

Preferred compounds of the formula 1 are those, in which

R1 is methyl,

R2a and R2b are both hydrogen or together denote a bond,

R3 is tert-butyl,

R4 is methyl and

R5 is methyl,

and their salts.

The compounds according to the invention can be prepared, for example, according to the following reaction scheme.

Scheme

In the scheme below, the preparation of a compound 1, where R2a and R2b are both hydrogen (=compounds of formula 1a), is outlined by way of example.

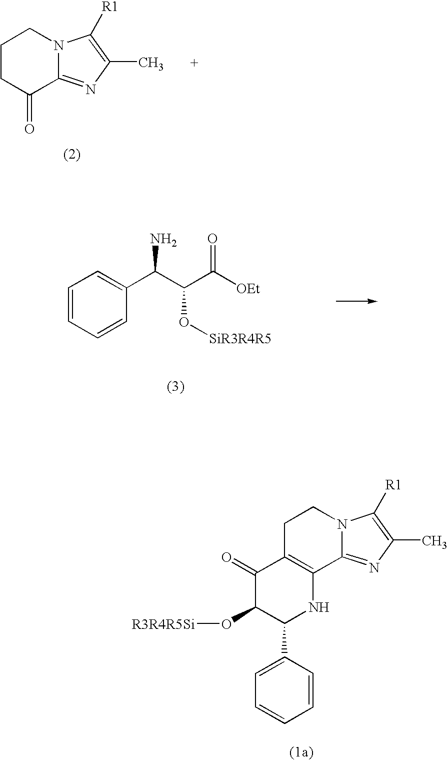

The starting compound of formula (2) is known from WO01/172748. The silyl ether of formula (3), which is also subject matter of the invention, can be prepared according to methods known to the expert, for example by reacting phenylisoserine ethyl ester with tert-butyl-dimethylsilyl chloride under basic conditions. The reaction of (2) and (3) is preferably carried out in the presence of a suitable catalyst, for example p-toluenesulfonic acid, and under simultaneous removal of water. The initial formation of an intermediate imine is followed by a ring closure, which is performed by using a strong base, for example potassium tert-butylate, lithium tert-butylate, sodium bis(trimethylsilyl)amide or preferably lithium diisopropylamide.

For the preparation of compounds of formula 1, in which R2a and R2b together denote a bond (=compounds of formula 1b) 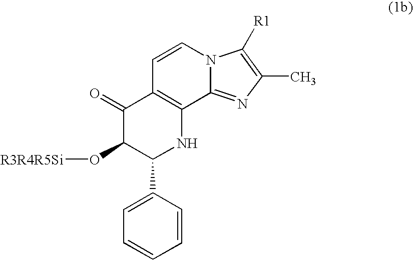
the compounds of formula 1a are dehydrogenated (oxidized) with suitable agents, for example with manganese dioxide, 1,3-dichloro-5,5-dimethylhydantoin or 2,3-dichloro-5,6-dicyano-p-benzochinone (DDQ). The 8-hydroxy-7-oxo-7,8,9,10-tetrahydroimidazo[1,2-h][1,7]naphthyridine, which is given for example in scheme 8 of international patent application WO98/142707 as intermediate, is obtained from compounds 1b by hydrolysis, for example with hydrochloric acid. The invention thus also relates to the use of the compounds of formula 1b for the production of compounds of formula 4 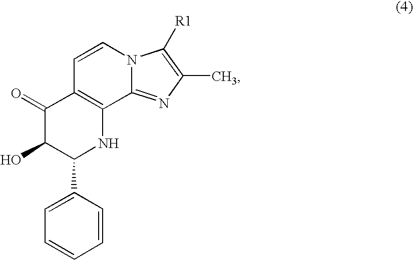
by hydrolysis of the compounds of formula 1b.

The following examples serve to illustrate the invention in greater detail without restricting it. Likewise, further compounds of the formula 1 whose preparation is not described explicitly can be prepared in an analogous manner or in a manner familiar per se to the person skilled in the art using customary process techniques. The abbreviation min stands for minute(s) and h for hour(s).

### EXAMPLES

### 1. t-Butyl-dimethyl-silylether of phenyl isoserine ethyl ester

1323 g (4.06 mole) of (R,R)-phenylisoserine ethyl ester are dissolved in 6.6. L of dichloromethane. To this solution, 397.4 g of imidazole and 724 g of t-butyldimethylsilyl chloride are added. The mixture is stirred for 16 hrs at RT. The reaction mixture is washed subsequently with 6 L and 4 L of water. The resulting clear dichloromethane layer is dried over sodium sulphate, filtered and concentrated under reduced pressure. The obtained 1509 g of the title compound are used as such in Example 2 without further purification.

### 2. 7-(t-Butyl-dimethyl-silanyloxy)-2,3-dimethyl-8-phenyl-5,7,8,9-tetrahydro-4H-1,3a,9-triaza-cyclopenta[a]naphthalen-6-one

To 1509 g of t-butyl-dimethyl-silylether of phenyl isoserine ethyl ester (obtained in Example 1), dissolved in 10.5 L of toluene, 14 g of p-toluenesulphonic acid monohydrate and 736 g of 2,3-dimethyl-6,7-dihydro-5H-imidazo[1,2-a]pyridin-8-one are added. The mixture is stirred and boiled under reflux until 80 mL of water are collected in the Dean-Stark trap used. The mixture is cooled to −15° C. and 6 L of THF are added. To this solution, 6 L of 2 M lithium-diisopropylamide (solution in THF/n-heptane) are added dropwise within 1 hr. The mixture is stirred for 30 min. without external cooling (the temperature rises to −5° C.) and then quenched with 7 L of aqueous ammonium chloride solution. The two layers are separated. The organic layer is dried over sodium sulphate and filtered. After removal of the solvents in vacuo, 1811 g of crude 7-(tert-butyl-dimethyl-silanyloxy)-2,3-dimethyl-8-phenyl-5,7,8, 9-tetrahydro-4H-1,3a,9-triaza-cyclopenta[a]naphthalen-6-one are isolated. This material is dissolved in 3.9 L of boiling methanol and cooled to −5° C. while stirring. The formed precipitate is collected and rinsed with 1.75 L of cold methanol. After drying, 558 g of the title compound are obtained. The mother liquor is concentrated to 1.5 L and stirred at −5° C. for several hours. The precipitate is collected and rinsed with 0.25 L of methanol. Another portion of 96.5 g of the title compound are isolated. Total yield is 654.5 g (38.5%).

### 3. 7-(t-Butyl-dimethyl-silanyloxy)-2,3-dimethyl-8-phenyl-8,9-dihydro-7H-1,3a,9-triaza-cyclopenta[a]naphthalen-6-one

558 g (1.32 mole) of 7-(tert-butyl-dimethyl-silanyloxy)-2,3-dimethyl-8-phenyl-5,7,8,9-tetrahydro-4H-1,3a,9-triaza-cyclopenta[a]naphthalen-6-one are dissolved in 2.6 L of THF and 5.36 L of toluene. The mixture is stirred and cooled in an ice/water bath at 5° C. 376 g (1.66 mole) of DDQ are added in portions during 1 hour. Stirring is continued for additional 2 hours at 15° C. After the oxidation is completed (checked by HPLC), the reaction mixture is quenched with 2.066 L of aqueous 2 M sodium hydroxide solution. The obtained suspension is filtered and the filter cake is rinsed with 1 L of toluene. The filtrate, a two layer system, is separated and the organic layer is washed with 2 L of 10% aqueous sodium chloride. After drying over sodium sulphate, the organic layer is filtered and concentrated under reduced pressure. The crude product is treated with 0.5 L of methanol and again concentrated in vacuo. The crude 536 g of the title compound are dissolved in 700 mL of methanol and cooled to −15° C. The formed precipitate is collected, rinsed with 100 mL of cold methanol (−15° C.) and dried. 342 g of the title compound are obtained as a yellow solid.

### 4. 7-Hydroxy-2,3-dimethyl-8-phenyl-8,9-dihydro-7H-1,3a,9-triaza-cyclopenta[a]naphthalen-6-one

386.5 g (0.916 mole) of 7-(t-butyl-dimethyl-silanyloxy)-2,3-dimethyl-8-phenyl-8,9-dihydro-7H-1,3a,9-triaza-cyclopenta[a]naphthalen-6-one are suspended in 1.4 L of methanol and cooled on an ice/water bath to 10° C. Then 0.734 L of 30% aqueous hydrochloride solution are added. The suspension becomes clear and after a few seconds a new precipitate is formed. The resulting suspension is stirred for two hours. After addition of 1.1 L of 25% aqueous ammonia the basic suspension (pH=9.6) is stirred for 1 hour. The formed solid is collected and rinsed with 1.1 L water and dried. To remove remaining silyl starting material, the solid is rinsed with 1 L of diethyl ether and dried again. 273.5 g of the title compound are obtained.

1. A compound of the formula 1, 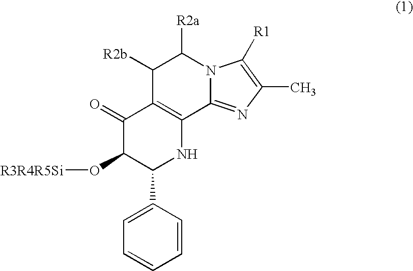
in which
R1 is hydrogen, methyl or hydroxymethyl,
R2a and R2b are both hydrogen or together denote a bond,
R3 is 1-7C-alkyl,
R4 is 1-7C-alkyl and
R5 is 1-7C-alkyl,
or a salt thereof.

2. A compound of the formula 1 according to claim 1, in which
R1 is methyl,
R2a and R2b are both hydrogen or together denote a bond,
R3 is 1-7C-alkyl,
R4 is 1-4C-alkyl and
R5 is 1-4C-alkyl,
or a salt thereof.

3. A compound of the formula 1 according to claim 1, in which
R1 is methyl,
R2a and R2b are both hydrogen or together denote a bond,
R3 is tert-butyl,
R4 is methyl and
R5 is methyl,
or a salt thereof.

4. A compound of the formula 1 according to claim 1, in which
R2a and R2b are both hydrogen and which is characterized by the formula 1a, 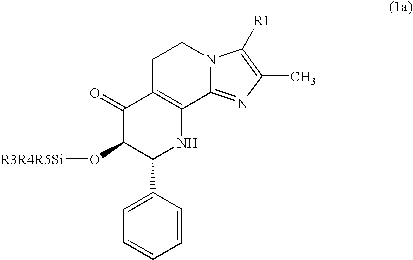
in which
R1 is hydrogen, methyl or hydroxymethyl,
R3 is 1-7C-alkyl,
R4 is 1-7C-alkyl and
R5 is 1-7C-alkyl,
or a salt thereof.

5. A compound of the formula 1 according to claim 1, in which
R2a and R2b together denote a bond and which is characterized by the formula 1b, 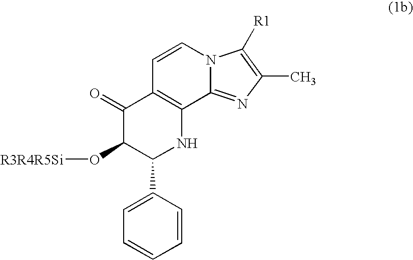
in which
R1 is hydrogen, methyl or hydroxymethyl,
R3 is 1-7C-alkyl,
R4 is 1-7C-alkyl and
R5 is 1-7C-alkyl,
or a salt thereof.

6. A process for the production of a compound of formula 1a according to claim 4, 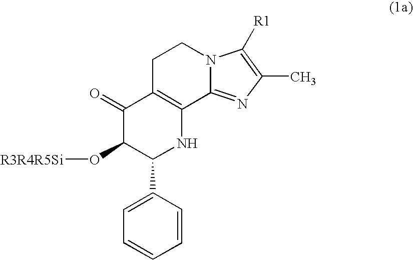
which comprises reacting a compound of formula 2, 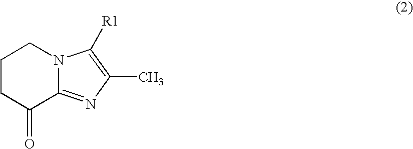
in which R1 has the meaning given in claim 4, with a compound of formula 3, 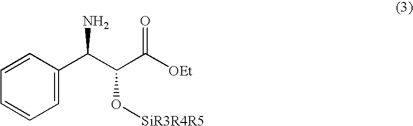
in which R3, R4 and R5 have the meanings given in claim 4 to produce an imine intermediate, and subjecting the imine intermediate to a ring closure reaction.

7. A compound of formula 3 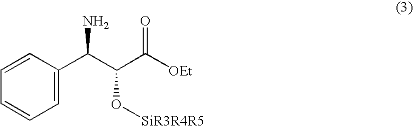
in which
R3 is 1-7C-alkyl,
R4 is 1-7C-alkyl and
R5 is 1-7C-alkyl
or a salt thereof.

8. A process of preparing a compound of formula 4 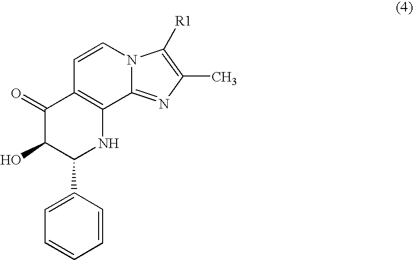
in which
R1 is hydrogen, methyl or hydroxymethyl,
comprising hydrolyzing the compound of formula 1b 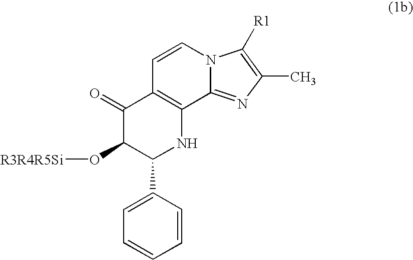
in which
R1 is hydrogen, methyl or hydroxymethyl,
R3 is 1-7C-alkyl,
R4 is 1-7C-alkyl and
R5 is 1-7C-alkyl,
or a salt thereof.
